(19) United States
(12) Patent Application Publication
(10) Pub. No.: US 2014/0047765 A1
(43) Pub. Date: Feb. 20, 2014

(54) SUSPENDED PORTABLE GARDEN WITH GREENHOUSE

(71) Applicants: James Howard Wescott, Cedar Rapids, IA (US); Julie Ann Jones, San Diego, CA (US)

(72) Inventors: James Howard Wescott, Cedar Rapids, IA (US); Julie Ann Jones, San Diego, CA (US)

(21) Appl. No.: 13/586,834

(22) Filed: Aug. 15, 2012

(51) Int. Cl. A01G 9/16

(52) U.S. Cl. 47/17

(57) ABSTRACT

A suspended, portable, tilting garden on a frame with a greenhouse and nutrient capturing capabilities solves the issues of poor soil, limited gardening space, portability, limited sunlight and cool temperatures, excess water usage and handicap accessibility. The garden also solves issues of flooding, loss of nutrients, ground pests and rodents. The medium is controlled because there is no walking space needed, allowing growing in the entire surface of the garden. The garden is on wheels so it is fully portable. The garden tilts to take full advantage of the sun and it has a greenhouse cover with passive and active solar heat distribution. Since the garden is raised, it is wheelchair accessible and makes it easy for elderly to stand and garden.

### BACKGROUND OF THE INVENTION

The present invention relates to gardens and greenhouses and more particularly, to a suspended, portable, tilting garden with a greenhouse and nutrient capturing capabilities.

With conventional gardening, there are issues with poor soil, limited gardening space, inability to take stationary gardens with you when moving, limited sunlight and cool temperatures, excess water usage and inaccessibility if the gardener is handicapped.

Raised bed or conventional gardens can flood, lose nutrients and be susceptible to ground pests and rodents. Other raised beds are not portable and most just contain a medium raised off the ground a few inches and don't make it considerably easier to garden or take into factors of sunlight, water, warmth and extended seasons, for example.

As can be seen, there is a need for an improved gardening apparatus that can be portable, tiltable and have greenhouse features.

### SUMMARY OF THE INVENTION

In one aspect of the present invention, a suspended portable garden system comprises a support structure; first and second support rails running along opposing sides of the support structure; a mesh disposed in the support structure, extending between the first and second support rails; a barrier sheet disposed over the mesh; a tilt frame supporting the support structure and permitting the support structure to tilt; and a greenhouse cover removably disposed over the support structure.

In another aspect of the present invention, a suspended portable garden system comprises a support structure; first and second support rails running along opposing sides of the support structure; a mesh disposed in the support structure, extending between the first and second support rails; insulation disposed under at least a portion of the mesh; a barrier sheet disposed over the mesh; a tilt frame supporting the support structure and permitting the support structure to tilt; a greenhouse cover removably disposed over the support structure; hinges connecting the greenhouse cover to a hinge support attached to the support structure; tubing communicating with air inside the greenhouse cover on a first end of and communicating within planting medium disposed on the barrier sheet; a fan driving air from inside the greenhouse cover to within the planting medium; and a solar cell providing power for the fan.

These and other features, aspects and advantages of the present invention will become better understood with reference to the following drawings, description and claims.

### BRIEF DESCRIPTION OF THE DRAWINGS

FIG. 1 is a perspective view of a suspended, portable garden according to an exemplary embodiment of the present invention;

FIG. 2 is an exploded perspective view of the suspended, portable garden of FIG. 1;

FIG. 3 is a cross-sectional view taken along line 3-3 of FIG. 1;

FIG. 4 is a cross-sectional view taken along line 4-4 of FIG. 1; and

FIG. 5 is an end view of the suspended, portable garden of FIG. 1, showing the support structure permitting tilting of the garden according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a suspended, portable, tilting garden on a frame with a greenhouse and nutrient capturing capabilities. The garden of the present invention solves the issues of poor soil, limited gardening space, portability, limited sunlight and cool temperatures, excess water usage and handicap accessibility. The garden also solves issues of flooding, loss of nutrients, ground pests and rodents. The medium is controlled because there is no walking space needed, allowing growing in the entire surface of the garden. The garden is on wheels so it is fully portable. The garden tilts to take full advantage of the sun and it has a greenhouse cover with passive and active solar heat distribution. The garden of the present invention allows the user to go from seed, to plant, to table without the need for transplanting or moving the plants as the develop. Since the garden is raised, it is wheelchair accessible and makes it easy for elderly to stand and garden.

The garden of the present invention can be accessed from each side. Therefore, unlike conventional garden plots that require a walking path in between rows accessing the plants, the garden of the present invention can use its entire surface for plants. For example, a 4-foot by 6-foot garden of the present invention can contain the same number of plants and provide a similar harvest as compared to a conventional 10-foot by 12-foot garden plot.

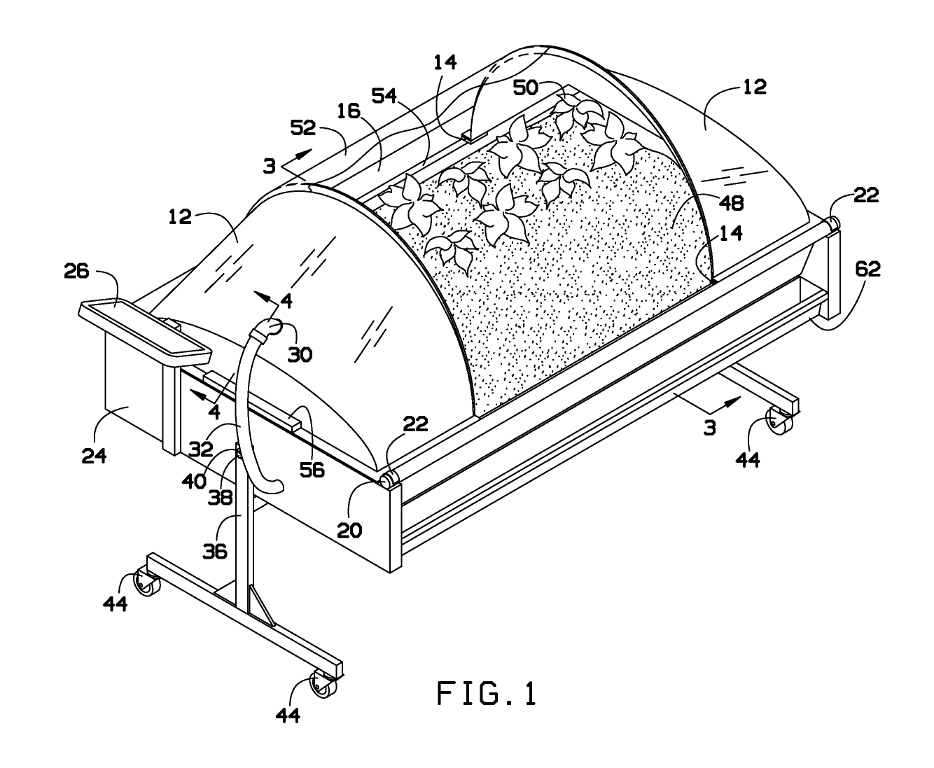

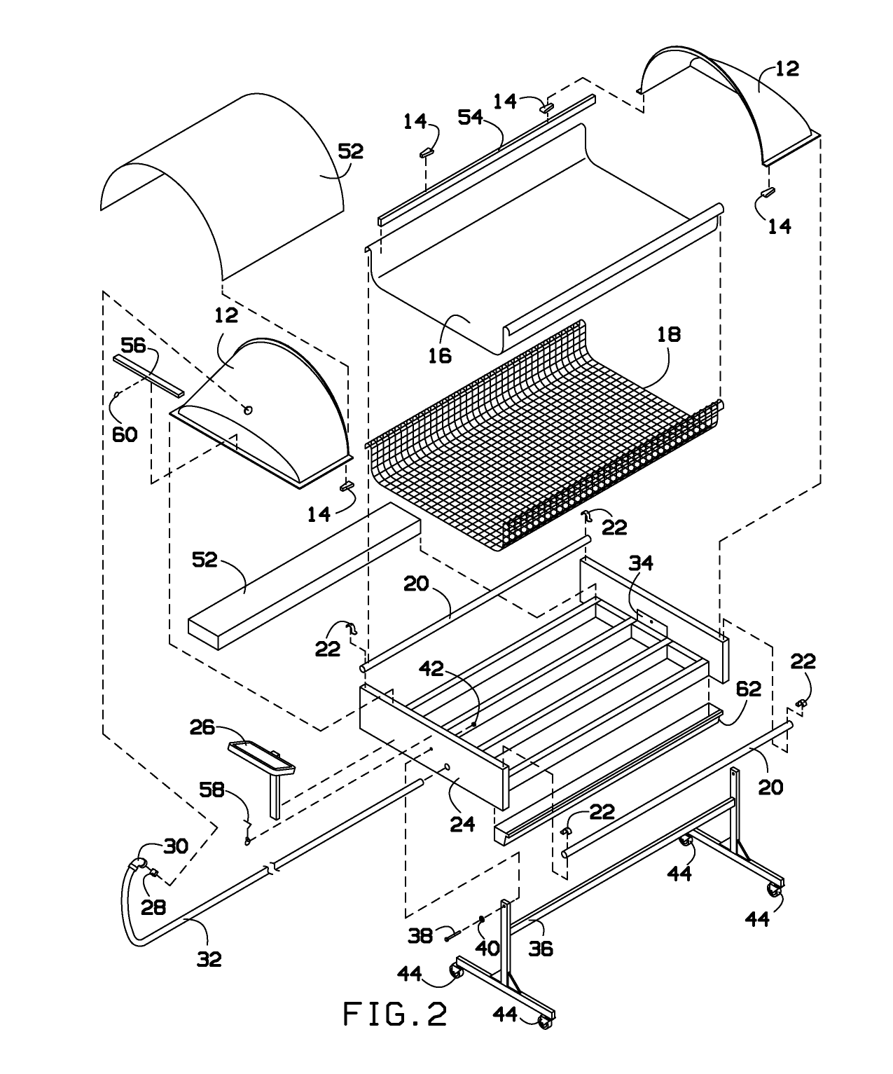

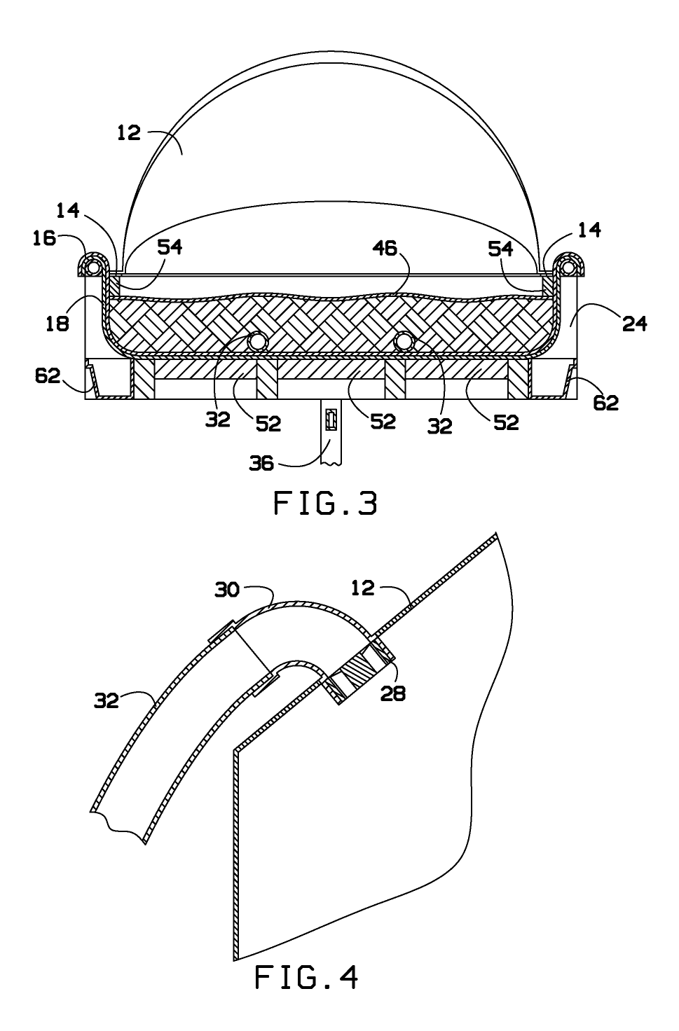

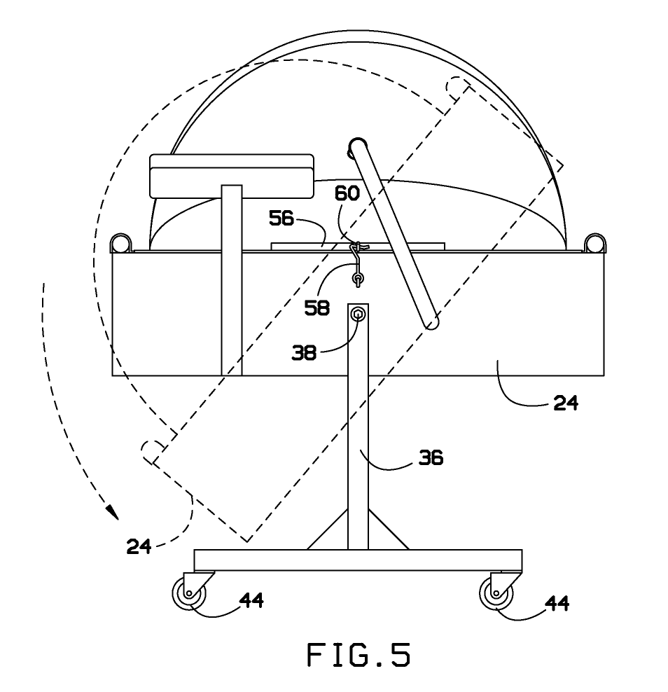

Referring now to FIGS. 1 through 5, a suspended portable garden system can include a garden bed system, a tilt frame, a power system, a circulation system and a greenhouse system. The below describes an exemplary assembly of each of these systems and their interconnection with reference to the drawings. The specific assembly described below may be modified with equivalent materials or mechanisms that provide the same effect, within the scope of the present invention.

The garden bed system includes a support structure 24. The support structure 24 supports a screen mesh 18 and a barrier sheet 16 thereupon. Support rails 20 can span along two sides of the support structure 24. Various mechanisms, such as support rail clamps 22, can be used to secure the support rails to the support structure 24. The barrier sheet 16 and the screen mesh 18 can loop over the support rails 20 to provide two opposing sides of a garden bed. The other two opposing sides of the garden bed can be defined by ends of the support structure 24.

Insulation panels 52, such as 2-inch Styrofoam insulation panels, can be disposed in the bottom of the support structure 24. The insulation panels 52 can help maintain growing media temperature in the garden bed. A rain gutter 62 can be disposed along sides of the garden bed system to direct water flow as may be desired.

Transparent greenhouse shells 12 can be disposed over the barrier sheet at each end thereof. A plastic sheet insulation 52 can be disposed between the transparent greenhouse shells 12 to provide an enclosed greenhouse structure over planting medium 48 and/or plants 50 in the system of the present invention.

A hinge support 54 can be attached to the support structure 24. Hinges 14 can connect between the hinge support 54 and the transparent greenhouse shells 12 to allow easy access to the planting medium 48 and the plants 50 inside the garden. A latch support 56 can be disposed on ends of the transparent greenhouse shells 12. The latch support 56 can support a latching hook 58. A latch eye 60 can be disposed on the support structure 24, permitting the latch eye 60 to engage the latch eye 60, securing the transparent greenhouse shells 12 in their closed position as shown in FIG. 1.

A ventilation elbow 30 can be disposed in a hole in one of the transparent greenhouse shells. A ventilation duct 32 can connect with the ventilation elbow 30 can be disposed below the planting medium 48 and above the barrier sheet 16 in the garden. A fan 28, typically disposed in the ventilation elbow 30, can be used to move air from under the transparent greenhouse shells 12 to under the planting medium 48, helping to warm the planting medium 48.

A solar cell 26 can be used to provide power to the fan 28, allowing the fan 28 to operate without the need to provide power separately to the garden, making the garden truly portable.

A tilt frame 36 can support the support structure 24 at a single point on opposing ends thereof. A connection between the tilt frame 36 and the support structure 24 can be achieved via various mechanisms. For example, a pivot bolt 38 can be inserted through the tilt frame 36 and into each end of the support structure 24. One or more washers can be disposed on the pivot bolt 38 and a nut 42, such as a lock nut, can be disposed on the end of the pivot bolt 38. The pivot bolt 38 allows the support structure 24 (and therefore the garden itself) to tilt, allowing the user to “point” the garden at the sun, for example. Casters 44 can be disposed along the bottom of the tilt frame 36. The casters 44 can be pivoting casters, where one or more of the casters may be lockable to prevent undesired rolling of the garden system. When unlocked, the casters 44 allow the garden system to be moved, as needed.

The components of the garden system can be made of various materials. For example, the support structure 24 can be made typically of wood, but other materials, such as metal, composite, plastic, or the like, can be used. The tilt frame 36 can be made typically of metal, but may be made of other materials, including wood, composite, or the like. Similarly, the barrier sheet 16 and the screen mesh 18 can be made of various materials.

Other features may be contemplated within the scope of the present invention. For example, the garden system could include a hose connection, such as a quick disconnect hose connection. One or more sprinklers can be disposed on the sides of the garden and/or on top of the transparent greenhouse shells 12, for example. The sprinklers can provide an easy method for watering the garden. A sprinkler timer can be installed to control the watering as desired.

It should be understood, of course, that the foregoing relates to exemplary embodiments of the invention and that modifications may be made without departing from the spirit and scope of the invention as set forth in the following claims.

What is claimed is:

1. A suspended portable garden system comprising:
a support structure;
first and second support rails running along opposing sides of the support structure;
a mesh disposed in the support structure, extending between the first and second support rails;
a barrier sheet disposed over the mesh;
a tilt frame supporting the support structure and permitting the support structure to tilt; and
a greenhouse cover removably disposed over the support structure.

2. The suspended portable garden system of claim 1, further comprising insulation disposed under at least a portion of the mesh.

3. The suspended portable garden system of claim 1, further comprising hinges connecting the greenhouse cover to a hinge support attached to the support structure.

4. The suspended portable garden system of claim 1, further comprising a latch system to secure the greenhouse cover to the support frame.

5. The suspended portable garden system of claim 1, further comprising tubing communicating with air inside the greenhouse cover on a first end of and communicating within planting medium disposed on the barrier sheet.

6. The suspended portable garden system of claim 5, further comprising a fan driving air from inside the greenhouse cover to within the planting medium.

7. The suspended portable garden system of claim 6, further comprising a solar cell providing power for the fan.

8. The suspended portable garden system of claim 1, further comprising a plurality of casters on a bottom portion of the tilt frame, the casters rolling to assist in movement of the suspended portable garden system.

9. The suspended portable garden system of claim 1, further comprising gutters disposed on each side of the support frame.

10. A suspended portable garden system comprising:
a support structure;
first and second support rails running along opposing sides of the support structure;
a mesh disposed in the support structure, extending between the first and second support rails;
insulation disposed under at least a portion of the mesh;
a barrier sheet disposed over the mesh;
a tilt frame supporting the support structure and permitting the support structure to tilt;
a greenhouse cover removably disposed over the support structure;
hinges connecting the greenhouse cover to a hinge support attached to the support structure;
tubing communicating with air inside the greenhouse cover on a first end of and communicating within planting medium disposed on the barrier sheet;
a fan driving air from inside the greenhouse cover to within the planting medium; and
a solar cell providing power for the fan.
